(19) United States
(12) Patent Application Publication
(10) Pub. No.: US 2026/0261500 A1
(43) Pub. Date: Sep. 3, 2026

(54) GENERATION OF REAL-TIME METRICS OF EDGE-TO-EDGE NETWORK

(71) Applicant: Level 3 Communications, LLC, Denver, CO (US)

(72) Inventors: John A. Schiel, Arvada, CO (US); Ryan M. Traum, Salt Lake City, UT (US)

(73) Assignee: Level 3 Communications, LLC, Denver, CO (US)

(21) Appl. No.: 19/374,395

(22) Filed: Oct. 30, 2025

Related U.S. Application Data
(60) Provisional application No. 63/764,732, filed on Feb. 28, 2025.

(51) Int. Cl. H04L 43/10; G06F 16/23; H04L 43/0888

(52) U.S. Cl. CPC H04L 43/10; G06F 16/2379; H04L 43/0888

(57) ABSTRACT

Novel tools and techniques are provided for implementing generation of real-time metrics of an edge-to-edge network. In examples, a CPE, located at a customer premises, sends a test packet(s) to a responder server in a core network over a path therebetween through a metro network. The CPE receives a response to the test packet(s) from the responder server, and measures network characteristics, based on the response. The CPE stores the network characteristics as part of first data in a local memory of the CPE, and pushes the first data to a cloud storage database in which is stored a digital twin of the first data. An orchestration system aggregates network characteristics data from digital twins of data associated with a plurality of CPE, identifies patterns by analyzing collected network characteristics data, and generates and sends a report containing the identified patterns and suggested actions for the identified patterns.

### CROSS-REFERENCE TO RELATED APPLICATIONS

This application claims the benefit of U.S. Provisional Application No. 63/764,732 filed Feb. 28, 2025, entitled "Generation of Real-Time Metrics of Edge-to-Edge Network," which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing generation of real-time metrics of an edge-to-edge network.

### BACKGROUND

Typically, for network testing, a server in a network of a service provider sends test packets to a customer premises equipment ("CPE") located at a customer premises, receives a response from the CPE, and measures network characteristics of the network between the server and the CPE based on the response. For CPE that have a dynamic IP address, however, the constant changing of the IP address necessitates constant re-mapping by the server of new IP addresses assigned to the CPE and an identifier of the CPE, which is time consuming and resource intensive. Further, obtaining data stored on CPEs for edge-to-edge network metrics analysis typically necessitates sending a request to the CPEs over the network, and waiting for the response to be sent by the CPEs, which may take some time. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing generation of real-time metrics of an edge-to-edge network, in accordance with various embodiments.

FIG. 2 depicts an example system illustrating communication exchange between a CPE and a responder or a network/aggregation gateway(s) when implementing generation of real-time metrics of an edge-to-edge network, in accordance with various embodiments.

FIG. 3 depicts a flow diagram illustrating an example method for implementing generation of real-time metrics of an edge-to-edge network, in accordance with various embodiments.

FIGS. 4A and 4B depict flow diagrams illustrating another example method for implementing generation of real-time metrics of an edge-to-edge network, in accordance with various embodiments.

FIGS. 5A and 5B depict flow diagrams illustrating yet another example method for implementing generation of real-time metrics of an edge-to-edge network, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

In examples, a CPE, which is located at a customer premises, may send at least one test packet to a responder server in a core network over a path between the CPE and the responder server through a metro network. The CPE may receive a response to the at least one test packet from the responder server, and may measure one or more network characteristics, based on the response. The CPE may store the one or more network characteristics as part of first data in a local memory of the CPE, and may push the first data to a cloud storage database in which is stored a digital twin of the first data. An orchestration system may aggregate a plurality of network characteristics data from digital twins of data associated with a plurality of CPE (e.g., thousands, tens of thousands, or more CPE), may identify patterns (including trends, etc.) by analyzing collected network characteristics data, and may generate and send a report containing the identified patterns and suggested actions for the identified patterns.

These and other aspects of the generation of real-time metrics of an edge-to-edge network are described in greater detail with respect to the figures. In the manner above, unlike the typical techniques for network testing in which the server in the network initiates and performs network testing, the system need not constantly re-map new IP addresses assigned to each CPE and an identifier of that CPE (e.g., a serial number of that CPE, etc.). Further, the plurality of CPE pushing data stored on their local memory (e.g., about every 30 seconds, etc.) to a cloud storage database (in which is stored the corresponding digital twins of data) places real-time or near-real-time data within proximity to an orchestration system, particularly where the orchestration system and the cloud storage database are both located within a core network of the service provider, provides for real-time (or near-real-time) analysis of the real-time (or near-real-time) metrics across thousands, tens of thousands, or more CPE, and aggregation of the analyzed (or measured) data. This is because there is no need for a request for such data to be sent to the CPEs over the network, and waiting for the response to be sent by the CPEs, followed by analysis by the orchestration system.

These and other aspects of the generation of real-time metrics of the edge-to-edge network are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes "a" through "n" may be used, where n denotes any suitable non-negative integer number (unless it denotes the number 14, if there are components with reference numerals having suffixes "a" through "m" preceding the component with the reference numeral having a suffix "n"), and may be either the same or different from the suffix "n" for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term "about." In this application, the use of the singular includes the plural unless specifically stated otherwise, and use of the terms "and" and "or" means "and/or" unless otherwise indicated. Moreover, the use of the term "including," as well as other forms, such as "includes" and "included," should be considered non-exclusive. Also, terms such as "element" or "component" encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase "at least one of element A, element B, or element C" (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including sending, by a CPE that is located at a customer premises, at least one first test packet to a responder server in a core network of a service provider over a path between the CPE and the responder server through a metro network of the service provider; receiving, by the CPE, a response to the at least one first test packet from the responder server; measuring, by the CPE, one or more network characteristics, based on the response; storing, by the CPE, the one or more network characteristics as part of first data in a local memory of the CPE; and pushing, by the CPE, the first data, which is stored in the local memory of the CPE, to a cloud storage database in which is stored a digital twin of the first data.

In another aspect, the technology relates to a system, including a first CPE that is located at a first customer premises, the first CPE performing first operations; a second CPE that is located at a second customer premises, the second CPE performing second operations; and an orchestration system. The orchestration system includes a processing system and memory coupled to the processing system. The memory includes computer executable instructions that, when executed by the processing system, causes the orchestration system to perform third operations. The first operations include sending at least one first test packet to a responder server in a core network of a service provider over a first path between the first CPE and the responder server through a metro network of the service provider; receiving a first response to the at least one first test packet from the responder server; measuring one or more first network characteristics, based on the first response; storing the one or more first network characteristics as part of first data in a first local memory of the first CPE; and pushing the first data, which is stored in the first local memory, to a cloud storage database in which is stored a digital twin of the first data.

The second operations include sending at least one second test packet to the responder server in the core network of the service provider over a second path between the second CPE and the responder server through the metro network of the service provider; receiving a second response to the at least one second test packet from the responder server; measuring one or more second network characteristics, based on the second response; storing the one or more second network characteristics as part of second data in a second local memory of the second CPE; and pushing the second data, which is stored in the second local memory, to the cloud storage database in which is stored a digital twin of the second data. The third operations include accessing the one or more first network characteristics, which is associated with the first CPE, from the digital twin of the first data; accessing the one or more second network characteristics, which is associated with the second CPE, from the digital twin of the second data; aggregating one or more groups of network characteristics data, among the one or more first network characteristics and the one or more second network characteristics, into one or more aggregated datasets; identifying patterns in the one or more aggregated datasets, by analyzing collective network characteristics data contained within each aggregated dataset among the one or more aggregated datasets; generating a report containing the patterns identified in the one or more aggregated datasets and containing suggested actions in response to patterns identified in the one or more aggregated datasets; and sending the report to a device.

In yet another aspect, the technology relates to a method, including managing, by an orchestration system, each of a plurality of CPE, which is disposed at one of a corresponding plurality of customer premises, in terms of pushing of network characteristics among a plurality of network characteristics data from the plurality of CPE to a plurality of digital twins being stored in a cloud storage database, the plurality of network characteristics data each corresponding to network characteristics of a network of a service provider between a responder server in a core network of a service provider and one of the plurality of CPE; accessing, by the orchestration system, the plurality of network characteristics data from the plurality of digital twins of data that is stored in the cloud storage database; aggregating, by the orchestration system, one or more groups of network characteristics data, among the plurality of network characteristics data, that are associated with one or more groups of CPE, among the plurality of CPE, into one or more aggregated datasets; identifying, by the orchestration system, patterns in the one or more aggregated datasets, by analyzing collective network characteristics data contained within each aggregated dataset among the one or more aggregated datasets; generating, by the orchestration system, a report containing patterns identified in the one or more aggregated datasets and containing suggested actions in response to the patterns identified in the one or more aggregated datasets; and sending, by the orchestration system, the report to a device.

In another aspect, the technology relates to a system, including an orchestration system, including a processing system and a memory coupled to the processing system. The memory includes computer executable instructions that, when executed by the processing system, causes the orchestration system to perform operations including: accessing a plurality of network characteristics data, which is associated with a corresponding plurality of CPE that is disposed at a corresponding plurality of customer premises, from a plurality of digital twins of data that is stored in the corresponding plurality of CPE, the plurality of digital twins being stored in a cloud storage database, the plurality of network characteristics data each corresponding to network characteristics of a network of a service provider between a responder server in a core network of the service provider and one of the plurality of CPE; aggregating one or more groups of network characteristics data, among the plurality of network characteristics data, that are associated with one or more groups of CPE, among the plurality of CPE, into one or more aggregated datasets; identifying trends and patterns in the one or more aggregated datasets, by analyzing collective network characteristics data contained within each aggregated dataset among the one or more aggregated datasets; generating a report containing the trends and patterns identified in the one or more aggregated datasets and containing suggested actions in response to identified trends and patterns in the one or more aggregated datasets; and sending the report to a device.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

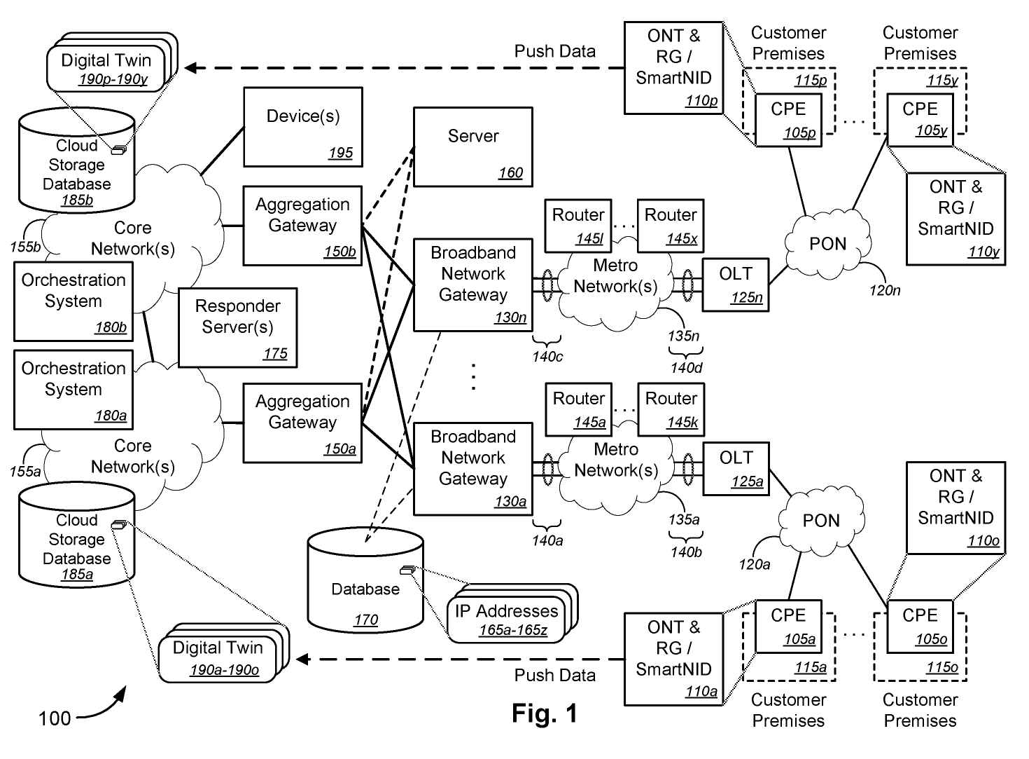

Turning to the embodiments as illustrated by the drawings, FIGS. 1-6 illustrate some of the features of methods, systems, and apparatuses for implementing generation of real-time metrics of an edge-to-edge network, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 depicts an example system 100 for implementing generation of real-time metrics of an edge-to-edge network, in accordance with various embodiments.

In examples, system 100 may include a plurality of CPE 105a-105o and 105p-105y (collectively, "CPE 105" or the like), each of which may include one of a corresponding plurality of pairs of optical network terminals ("ONTs") and residential gateways ("RGs") 110a-110o and 110p-110y (collectively, "ONTs/RGs 110" or the like), or a combination ONT/RG ("smart network interface device" or "SmartNID") among a plurality of SmartNIDs 110a-110o and 110p-110y. In examples, each of the plurality of CPE 105a-105o and 105p-105y is located or disposed within a corresponding one of the plurality of customer premises 115a-115o and 115p-115y (collectively, "customer premises 115" or the like). System 100 may further include a plurality of passive optical networks ("PONs") 120a-120n (collectively, "PONs 120" or the like), a plurality of optical line terminals ("OLTs") 125a-125n (collectively, "OLTs 125" or the like), a plurality of broadband network gateways 130a-130n (collectively, "broadband network gateways 130" or the like), a plurality of metro networks 135a-135n (collectively, "metro networks 135" or the like), a plurality of link aggregation groups ("LAGs") 140a-140d (collectively, "LAGs 140" or the like; each LAG being denoted by parallel lines bundled by a ring shape), and a plurality of routers 145a-145k and 145l-145x (collectively, "routers 145" or the like).

System 100 may further include a pair of aggregation gateways 150a and 150b (collectively, "aggregation gateways 150" or the like), core networks 155a and 155b (collectively, "core networks 155" or the like), and server 160. In examples, a list of IP addresses 165a-165z (collectively, "IP addresses 165" or the like) that are reserved for allocation or assignment to one or more of the plurality of CPE 105a-105o and 105p-105y or corresponding one or more of the plurality of pairs of ONTs and RGs or SmartNIDs 110a-110o and 110p-110y may be stored in a database 170. Herein, k, l, n, o, p, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

In examples, system 100 may further include responder server(s) 175, orchestration systems 180a and 180b, and cloud storage databases 185a and 185b. In some cases, one of the responder server(s) 175, the orchestration system 180a, and the cloud storage database 185a may be located or disposed within core network(s) 155a, while another one of the responder server(s) 175, the orchestration system 180b, and the cloud storage database 185b may be located or disposed within core network(s) 155b. Stored in cloud storage database 185a may be a plurality of digital twins 190a-190o corresponding to data stored in local memory in a corresponding plurality of CPE 105a-105o of a corresponding of pairs of ONTs and RGs or SmartNIDS 110a-110o. Similarly, stored in cloud storage database 185b may be a plurality of digital twins 190p-190y corresponding to data stored in local memory in a corresponding plurality of CPE 105p-105y of a corresponding of pairs of ONTs and RGs or SmartNIDS 110p-110y. In some cases, stored in either of cloud storage databases 185a and 185b may be a plurality of digital twins 190a-190o and 190p-190y corresponding to data stored in local memory in a corresponding plurality of CPE 105a-105o and 105p-105y of a corresponding plurality of pairs of ONTs and RGs or SmartNIDS 110a-110o and 110p-110y. In some examples, system 100 may further include device(s) 195, which may each include, but is not limited to, one of includes one of a console of a network operations center ("NOC"), a technician device associated with a field technician, an agent device associated with an agent of the service provider, or a user device associated with a customer of the service provider who is associated with a CPE with which the OLT is communicatively coupled over the PON, and/or the like. In some instances, the user device may include one of a desktop computer, a laptop computer, a tablet computer, a smart phone, a mobile phone, or any suitable user device, or the like.

In some cases, customer premises 115a-115o and 115p-115y may each include, but is not limited to, one of a residential customer premises, a business customer premises, a corporate customer premises, an enterprise customer premises, an education facility customer premises, a medical facility customer premises, or a governmental customer premises, and/or the like. In some instances, customers or users associated with the customer premises 115a-115o and 115p-115y, and/or associated with corresponding ones of the CPE 105a-105o and 105p-105y and/or of the pairs of ONTs and RGs or SmartNIDS 110a-110o and 110p-110y, may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

In examples, each PON 120 is a fiber-optic telecommunications network that uses unpowered devices to carry optical signals, and is typically used for the last mile between the customer premises 115 and the service provider network(s) (in this case, metro network(s) 135a-135n, core network(s) 155a and 155b, and components therein (including broadband network gateways 130a-130n, routers 145a-145k or 145l-145x, aggregation gateways 150a and 150b, server 160, database 170, responder server(s) 175, orchestration systems 180a and 180b, and cloud storage databases 185aand 185b, and/or the like). Each OLT 125 of a corresponding one of the PONs 120a-120n communicatively couples with a plurality of CPE 105a-105o or a plurality of CPE 115p-115y (or a corresponding plurality of pairs of ONTs and RGs or SmartNIDS 110a-110o and 110p-110y), and corresponding customer premises 115a-115oor customer premises 115p-115y. Each of OLTs 125a-125n communicatively couples with a corresponding one of broadband network gateways 130a-130n via corresponding one of metro networks 135a-135n via corresponding ones of LAGs 140a-140d and/or corresponding one or more of routers 145a-145k or 145l-145x. Each OLT 125 is configured to provide first optical data signals for transmission over the corresponding PON 120 to a plurality of CPE 105 located at customer premises 115 serviced by that PON 120, and configured to relay second optical data signals from the plurality of CPE 105 to the service provider network(s) or to convert the second optical data signals into first electrical data signals for transmission to the service provider network(s). Each CPE 105 is configured to convert the first optical data signals into second electrical data signals for communication with devices (in some cases, via radio transmission using communication protocols such as Bluetooth^{TM}, Wi-Fi, etc.) within the corresponding customer premises 115 that are communicatively coupled with that CPE 105, and configured to convert third electrical data signals received from the devices (in some cases, via electrical transmission or via radio transmission) into the second optical data signals for transmission to a corresponding OLT 125 via the corresponding PON 120.

Each one of broadband network gateways 130a-130n communicatively couples with each of aggregation gateways 150a and 150b. Each of aggregation gateways 150a and 150b communicatively couples with a corresponding one of core networks 155a or 155b, with server 160, and with database 170. A set of aggregation gateway 150a and 150b and core network(s) 155a or 155b provides parallel redundancy. Since each aggregation gateway 150a and 150b is communicatively coupled to each of the plurality of broadband network gateways 130a-130n, load balancing, failover, and/or maintenance (with one set taking over network operations while the other set is taken offline for maintenance) can be achieved. According to some embodiments, unless otherwise indicated, network(s) 135a-135n and 155a-155b may each include, without limitation, one of a local area network ("LAN"), including, without limitation, a fiber network, an Ethernet network, a Token-Ring™ network, and/or the like; a wide-area network ("WAN"); a wireless wide area network ("WWAN"); a virtual network, such as a virtual private network ("VPN"); the Internet; an intranet; an extranet; a public switched telephone network ("PSTN"); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, unless otherwise indicated, the network(s)135a-135n and 155a-155b may include an access network of the service provider (e.g., an Internet service provider ("ISP")). In another embodiment, unless otherwise indicated, the network(s) 135a-135n and 155a-155b may include a core network of the service provider and/or the Internet.

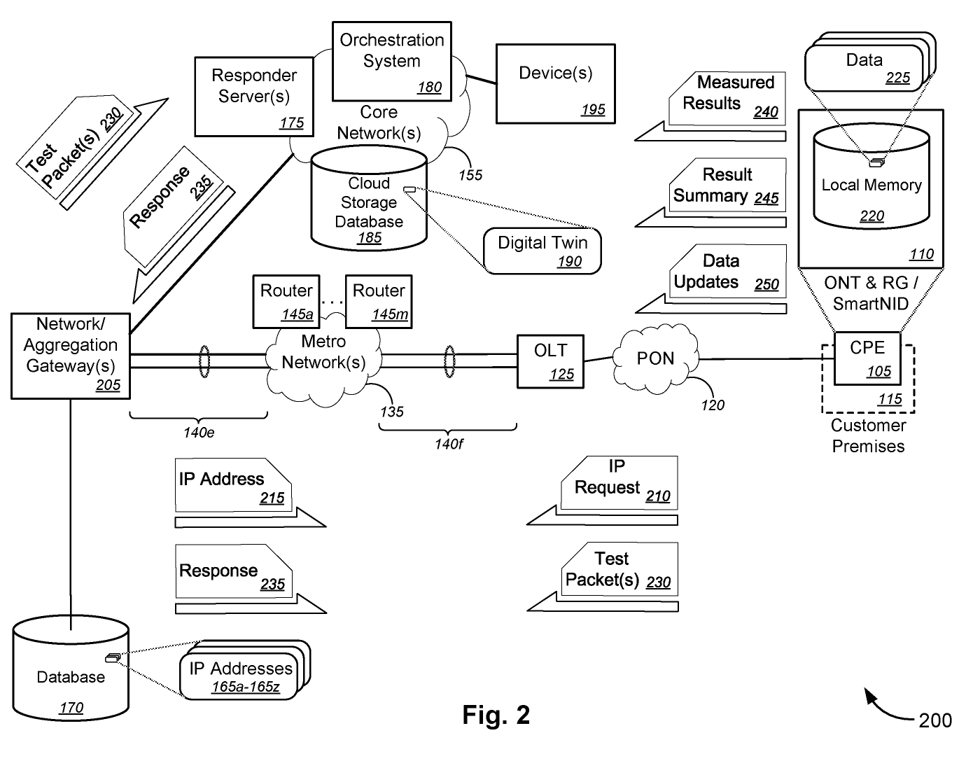

In examples, each of the plurality of CPE 105a-105o and 105p-105y has a dynamic IP address (e.g., an IP address among the IP addresses 165a-165z) that is assigned to that CPE by a network gateway (e.g., one of the broadband network gateways 130a-130n) in response to a dynamic host configuration protocol ("DHCP") request sent by that CPE according to one of the following conditions: on a periodic basis (e.g., every one, two, three, or more days, or every week, every other week, every third week, or every month, etc.), on a scheduled basis (at a set time(s) during each day, every other day, every third day, on particular days of the week and/or weekend, on particular days in a month, etc.), after rebooting of the CPE, or in response to a user input (e.g., in response to a reset button being depressed, in response to a submit DHCP request button being clicked or depressed, etc.). In some examples, data and/or updates to data that is stored in a local memory of a CPE 105 or a SmartNID 110 (which may include one or more network characteristics of a network through which data packets are transmitted to and/or from that CPE or SmartNID) may be pushed to a cloud storage database (e.g., one of cloud storage database 185a or 185b) to update a corresponding digital twin 190 among the plurality of digital twins 190a-190o and 190p-190y according to one of the following conditions: (1) on a periodic basis (e.g., every 10, 20, 30, or 60 seconds, or every other minute, every 5, 10, 15, 20, 30, or 60 minutes, or every hour, every other hour, every three or more hours, or every 24 hours, etc.); (2) on a scheduled basis (e.g., at a set time(s) during each day, etc.); (3) after receiving a set number of measured metrics (e.g., after receiving 1, 2, 3, 4, 5, 10, 12, 15, 20, 25, 50, 75, 100, 150, 200, or more measured metrics, etc.) associated with one or more network characteristics corresponding to one or more of the plurality of network characteristics data; (4) prior to shutdown of that CPE; (5) in response to a user input (e.g., in response to a push data button/option being clicked or depressed, in response to an update digital twin button/option being clicked or depressed, etc.); or (6) when raw data associated with a network characteristic among the one or more network characteristics that is measured by that CPE exceeds a threshold value (e.g., a set trigger value, a set percentage change from a previous value, etc.); or the like. As shown and described below with respect to FIG. 2, various examples of data can be pushed to the cloud storage database 185 to be stored as (or to update) a digital twin 190 of the data 225 stored in local memory 220 of the SmartNID 110 (or the CPE 105), as well as initiation of testing the network with the sending, by the SmartNID 110 (or the CPE 105), of a test packet(s) 230 and measuring one or more network characteristics based on a response 235 received from a responder server(s) 175.

In some aspects, an orchestration system 180a, which is located within a core network 155a of a service provider, may access a plurality of network characteristics data, which is associated with a corresponding plurality of CPE (e.g., CPE 105a-105o and/or 105p-105y) that is disposed at a corresponding plurality of customer premises (e.g., customer premises 115a-115o and/or 115p-115y), from a plurality of digital twins of data (e.g., digital twins 190a-190o and/or 190p-190y) that is stored in local memory of the corresponding plurality of CPE. In some examples, at least one of the plurality of CPE each includes a pair of ONT and RG among a plurality of pairs of ONTs and RGs 110a-110o and/or 110p-110y or a SmartNID among a plurality of SmartNIDs 110a-110o and/or 110p-110y, or the like. The plurality of digital twins is stored in a cloud storage database 185a, the plurality of network characteristics data each corresponding to network characteristics of a network of a service provider between a responder server 175 in the core network 155a of the service provider and one of the plurality of CPE 105.

In examples, the orchestration system 180a may aggregate one or more groups of network characteristics data, among the plurality of network characteristics data, that are associated with one or more groups of CPE (which may include thousands, tens of thousands, or more CPE, or the like), among the plurality of CPE 105, into one or more aggregated datasets. The orchestration system 180a may identify trends and patterns in the one or more aggregated datasets, in some cases, by analyzing collective network characteristics data contained within each aggregated dataset among the one or more aggregated datasets. The orchestration system 180a may generate a report containing identified trends and/or patterns in the one or more aggregated datasets and containing suggested actions in response to the trends and/or patterns identified in the one or more aggregated datasets. The orchestration system may send the report to a device 195, in some cases, via core network(s) 155a and/or 155b.

In some examples, each of the plurality of digital twins of data 190 corresponding to one of the plurality of CPE includes at least one of summary data associated with a summary of one or more network characteristics measured by that CPE 105 or raw data associated with the one or more network characteristics measured by that CPE 105. In examples, summary data associated with a summary of one or more network characteristics measured by each CPE 105 is stored in a separate database accessible by the orchestration system 180a. In such examples, the orchestration system 180a may access the summary data from the separate database, and may aggregate the one or more groups of network characteristics data and the summary data into one or more aggregated datasets. In some instances, the orchestration system 180a may identify the trends and patterns in the one or more aggregated datasets, in some cases, by analyzing a combination of collective network characteristics data contained within each aggregated dataset among the one or more aggregated datasets and the summary data (in some instances, using an artificial intelligence ("AI") system or AI functionalities, or the like).

In some examples, the one or more network characteristics include at least one of latency, packet loss, jitter, bandwidth, network speed, connectivity, or network performance, and/or the like. Latency corresponds to a time over which the at least one test packet is transmitted from and/or to the CPE to and/or from the responder server, where high latency (e.g., latency greater than 60 milliseconds (ms)) may be indicative of a long distance path between the CPE and the responder server, network congestion issues, and/or network transmission medium issues, and/or the like. Packet loss corresponds to a number of data packets among the at least one test packet that is lost during the exchange between the CPE and the responder server, where packet loss may be indicative of network congestion, aging hardware, software issues, etc. Jitter corresponds to a variation in time delay between when the at least one test packet is sent and when the at least one test packet is received over the network, where bad jitter values (e.g., greater than 50 ms) may be indicative of network congestion, poor hardware performance, routing issues, etc. Bandwidth corresponds to a maximum amount of data that can be transferred over the network in a given amount of time.

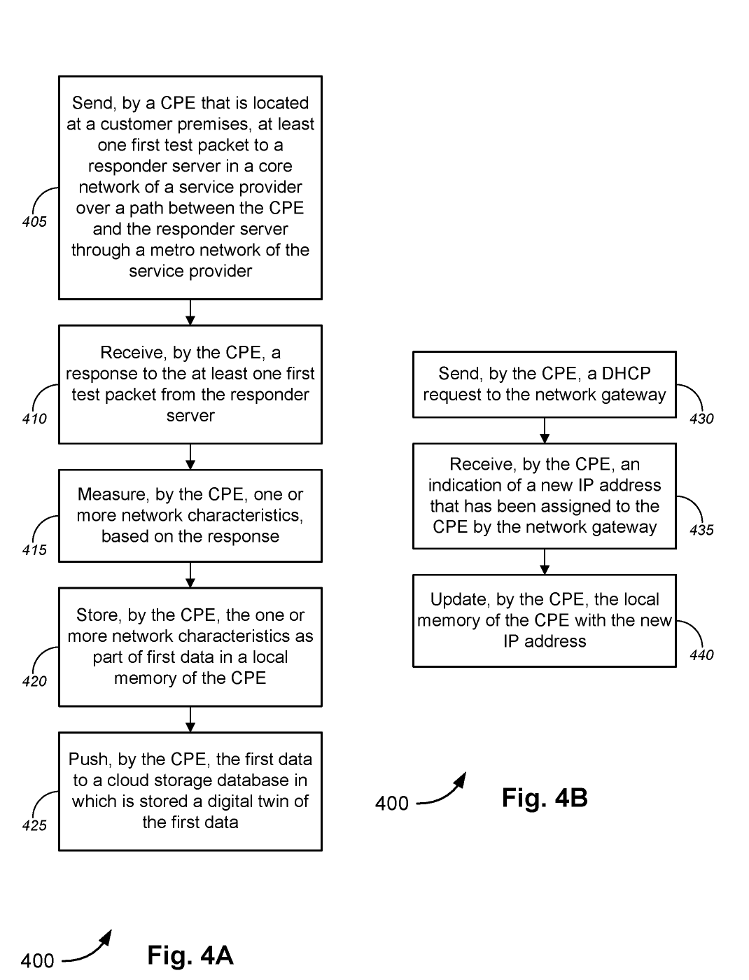

Network speed (or data transfer rate) corresponds to a rate at which data packets are transferred between two devices on the network (in this case, the rate at which the at least one test packet is transmitter from and/or to the CPE to and/or from the responder server). Connectivity (as used herein) corresponds to whether the CPE is connected to the network (e.g., over the Layer 3 path), in some cases, with a connectivity map or connectivity report being generated that tracks network nodes along the path through the network (e.g., as described in detail below with respect to FIG. 4A). In some examples, the connectivity map or connectivity report may be generated based on Internet control message protocol ("ICMP") packets that are sent along a path between the CPE and the responder server and based on ICMP timestamps for each router along the path (e.g., as described in detail below with respect to FIG. 4A). A network speed test may be performed to measure the network speed between the CPE and the responder server.

Network performance corresponds to quality and effectiveness of a network system, which is indicative of its speed, reliability, and efficiency. Network performance can be measured based on simple two-way active measurement protocol ("STAMP"), two-way active measurement protocol ("TWAMP"), and/or implementation of performance measurement and tuning, using a cross-platform tool (such as iPerf). In examples, cross-platform tools (like iPerf) either (A) measures a throughput of a payload that is sent over the path over TCP, and provides payload throughput measurement results, or (B) measures a throughput of a datagram that is sent over the path over UDP, and providing datagram throughput measurement results and packet loss results.

In some aspects, the CPE/SmartNIDs initiates and performs network testing (e.g., by sending the test packet(s), receiving the response for a responder server, and measuring the network characteristics based on the response, etc.), rather than a server in the network initiating and performing network testing. In examples, the data (including new IP addresses, network characteristics data, summary data, and/or the like) resides on the CPE/SmartNIDs, and the orchestration system(s) in the core network(s) manages the CPE/SmartNIDs to upload or push the data to the cloud storage database, according to one of the following conditions: (1) on a periodic basis; (2) on a scheduled basis; (3) after receiving a set number of measured metrics associated with one or more network characteristics corresponding to one or more of the plurality of network characteristics data; (4) prior to shutdown of that CPE/SmartNIDs; (5) in response to a user input; or (6) when raw data associated with a network characteristic among the one or more network characteristics that is measured by that CPE/SmartNIDs exceeds a threshold value; or the like. In the manner above, unlike the typical techniques for network testing in which the server in the network initiates and performs network testing, because the CPE/SmartNIDs initiates and performs network testing instead of the server in the network, the system need not constantly re-map new IP addresses assigned to each CPE/SmartNID and an identifier of that CPE/SmartNID (e.g., a serial number of that CPE/SmartNID, etc.).

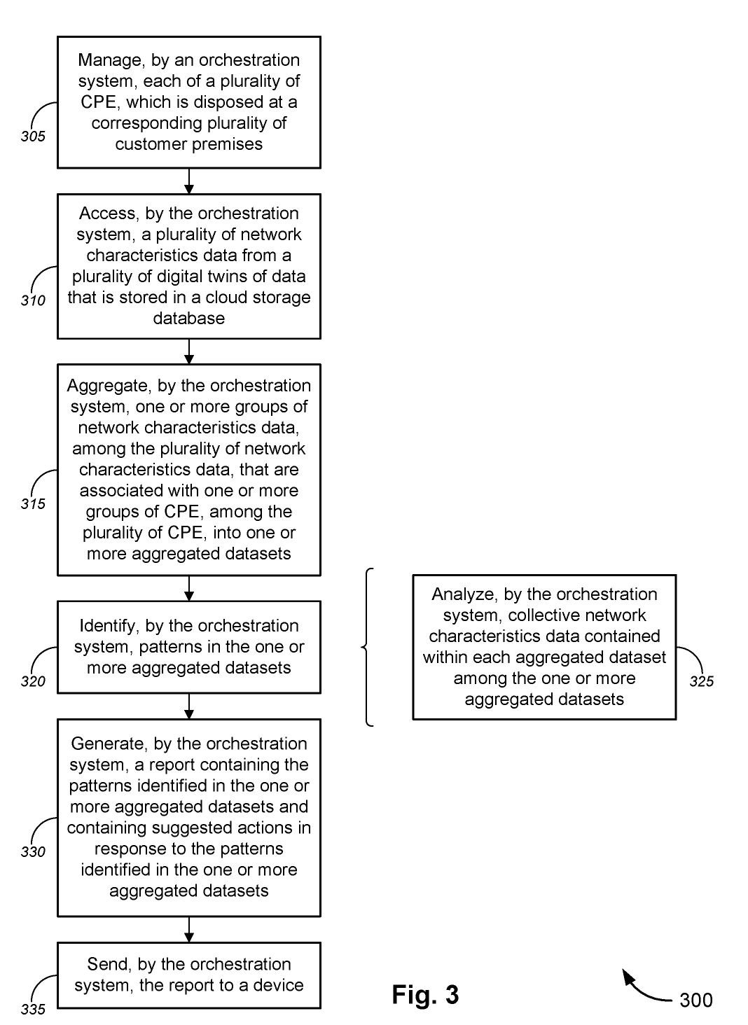

These and other functionalities of the system 100 particularly with respect to CPE 105 and/or orchestration system(s) 180 are described in detail below with respect to FIGS. 2-4. In operation, one or more of the plurality of CPE 105a-105o and 105p-105y, and/or orchestration system 180aor 180b (collectively, "computing system") may perform methods for implementing generation of real-time metrics of an edge-to-edge network, as described in detail with respect to FIGS. 2-5B. For example, communication exchanges as described below with respect to FIG. 2, example methods 300, 400, and 500 as described below with respect to FIGS. 3, 4A-4B, and 5A-5B, respectively, may be applied with respect to the operations of system 100 of FIG. 1.

FIG. 2 depicts an example system 200 illustrating communication exchange between a CPE and a responder or a network/aggregation gateway(s) when implementing generation of real-time metrics of an edge-to-edge network, in accordance with various embodiments. In some embodiments, CPE 105, ONT & RG/SmartNID 110, customer premises 115, PON 120, OLT 125, network/aggregation gateway(s) 205, metro network(s) 135, LAGs 140e and 140f, routers 145a-145m, core network(s) 155, IP addresses 165a-165z, database 170, responder server(s) 175, orchestration system 180, cloud storage database 185, digital twin 190, and device(s) 195 of FIG. 2 may be similar, if not identical, to the plurality of CPE 105a-105o and 105p-105y, the plurality of pairs of ONTs & RGs or the plurality of SmartNIDs 110a-110o and 110p-110y, the plurality of customer premises 115a-115o and 115p-115y, the plurality of PONs 120a-120n, the plurality of OLTs 125a-125n, the broadband network gateways 130a-130n and/or the aggregation gateways 150a and 150b, the metro networks 135a-135n, the LAGs 140a-140d, the plurality of routers 145a-145k and 145l-145x, the core networks 155a and 155b, the IP addresses 165a-165z, the database 170, the responder server(s) 175, the orchestration systems 180a and 180b, the cloud storage databases 185a and 185b, the plurality of digital twins 190a-190o and 190p-190y, and device(s) 195, respectively, of system 100 of FIG. 1, and the description of these components of system 100 of FIG. 1 are similarly applicable to the corresponding components of FIG. 2.

With reference to FIG. 2, example system 200 may include a CPE 105 that is located at a customer premises 115. The CPE 105 may include ONT & RG/SmartNID 110. In some instances, the CPE 105 and/or the ONT & RG/SmartNID 110 may include a local memory 220 on which is stored data 225 associated with or collected by the CPE 105 and/or the ONT & RG/SmartNID 110. Example system 200 may further include PON 120, OLT 125, network/aggregation gateway(s) 205, metro network(s) 135, LAGs 140e and 140f, routers 145a-145m, core network(s) 155, database 170, responder server(s) 175, orchestration system 180, cloud storage database 185, and device(s) 195. In some cases, the CPE 105 and/or the ONT & RG/SmartNID 110 communicatively couples with the network/aggregation gateway(s) 205 via the PON 120, the OLT 125, the metro network(s) 135, the LAGs 140eand 140f, and/or the routers 145a-145m, and/or the like. In some examples, the responder server(s) 175, the orchestration system 180, and/or the cloud storage database 185 may be disposed within the core network(s) 155. The network/aggregation gateway(s) 205 communicatively couples with the database 170 and/or at least one of the responder server(s) 175, the orchestration system 180, and/or the cloud storage database 185 in the core network(s) 155.

In operation, the CPE 105 and/or the ONT & RG/SmartNID 110 sends an IP request 210 for an IP address to the network/aggregation gateway(s) 205 (corresponding to a broadband network gateway among the broadband network gateways 130a-130nof FIG. 1, or the like), in some cases, via DHCP. In response to receiving the IP request 210, the network/aggregation gateway(s) 205 authenticates the CPE 105 and/or the ONT & RG/SmartNID 110, and assigns a first IP address, from among the IP addresses 165a-165z (stored in database 170) that are reserved for allocation or assignment to CPE, to the CPE 105 and/or the ONT & RG/SmartNID 110. In some examples, the network/aggregation gateway(s) 205 may send the first IP address 215 or an indication of the first IP address 215 to the CPE 105 and/or the ONT & RG/SmartNID 110, via the metro network(s) 135, the LAGs 140e and 140f, the routers 145a-145m, the OLT 125, and/or the PON 120, and/or the like. The CPE 105 and/or the ONT & RG/SmartNID 110 may store or update the local memory 220 with the first IP address 215 (e.g., by replacing and/or appending to portions of the data 225 that is stored in the local memory 220, or the like). In examples, the first IP address 215 is a dynamic IP address, and the IP request 210 is sent according to one of the following conditions: on a periodic basis, on a scheduled basis, after rebooting of the CPE 105 and/or the ONT & RG/SmartNID 110, or in response to a user input, and/or the like.

In some examples, the CPE 105 and/or the ONT & RG/SmartNID 110 may send a test packet(s) 230 to the responder server(s) 175 in the core network(s) 155 over a path between the CPE 105 and/or the ONT & RG/SmartNID 110 and the responder server(s) 175, in some cases. via the PON 120, the OLT 125, the metro network(s) 135, the LAGs 140e and 140f, and/or the routers 145a-145m, and via the network/aggregation gateway(s) 205. The CPE 105 and/or the ONT & RG/SmartNID 110 may receive a response 235 to the test packet(s) 230 from the responder server(s) 175, in some cases, via the network/aggregation gateway(s) 205 and via the metro network(s) 135, the LAGs 140e and 140f, the routers 145a-145m, the OLT 125, and/or the PON 120, and/or the like. The CPE 105 and/or the ONT & RG/SmartNID 110 may measure one or more network characteristics, based on the response 235, and may store the one or more network characteristics as part of data 225 in the local memory 220 of the CPE 105 and/or the ONT & RG/SmartNID 110. The CPE 105 and/or the ONT & RG/SmartNID 110 may push the data 225 (which may include measured results 240, a result summary 245, and/or data updates 250, or the like) to the cloud storage database 185 in the core network(s) 155, where the digital twin 190 may be updated with the pushed data 225.

FIG. 3 depicts a flow diagram illustrating an example method 300 for implementing generation of real-time metrics of an edge-to-edge network, in accordance with various embodiments. With reference to FIG. 3, the operations of example method 300 may be performed by an orchestration system(s) (e.g., orchestration system(s) 180a, 180b, or 180 of FIGS. 1 and 2, or the like).

In the example method 300 of FIG. 3, at operation 305, an orchestration system, which may be located within a core network (e.g., core network(s) 155a, 155b, and 155 of FIGS. 1 and 2, or the like) of a service provider, may manage each of a plurality of CPE (e.g., CPE 105a-105o, 105p-105y, and 105 of FIGS. 1 and 2, or the like), which is disposed at one of a corresponding plurality of customer premises (e.g., customer premises 115a-115o, 115p-115y, and 115 of FIGS. 1 and 2, or the like). In some cases, the orchestration system may manage the plurality of CPE in terms of pushing of network characteristics among a plurality of network characteristics data from the plurality of CPE to a corresponding plurality of digital twins (e.g., digital twins 190a-190o, 190p-190y, and 190 of FIGS. 1 and 2, or the like) being stored in a cloud storage database (e.g., cloud storage database 185a, 185b, and 185 of FIGS. 1 and 2, or the like). In some examples, the plurality of network characteristics data each corresponds to network characteristics of a network of the service provider between a responder server (e.g., responder server(s) 175 of FIGS. 1 and 2, or the like) in the core network of the service provider and one of the plurality of CPE. In some examples, at least one of the plurality of CPE each includes one of a plurality of pairs of ONTs and RGs 110a-110o, 110p-110y, and 110 or one of a plurality of SmartNIDs 110a-110o, 110p-110y, and 110 of FIGS. 1 and 2, or the like.

At operation 310, the orchestration system may access the plurality of network characteristics data, which is associated with the corresponding plurality of CPE, from the plurality of digital twins of data that is stored in the cloud storage database. In some instances, the cloud storage database (like the orchestration system) may be disposed in the core network. In some examples, the one or more network characteristics may include at least one of latency, packet loss, jitter, bandwidth, network speed, connectivity, or network performance, and/or the like. At operation 315, the orchestration system may aggregate one or more groups of network characteristics data, among the plurality of network characteristics data, that are associated with one or more groups of CPE, among the plurality of CPE, into one or more aggregated datasets.

At operation 320, the orchestration system may identify patterns (including trends, etc.) in the one or more aggregated datasets, in some cases, by analyzing collective network characteristics data contained within each aggregated dataset among the one or more aggregated datasets (at operation 325). At operation 330, the orchestration system may generate a report containing patterns identified in the one or more aggregated datasets and containing suggested actions in response to the patterns identified in the one or more aggregated datasets. At operation 335, the orchestration system may send the report to a device (e.g., device(s) 195 of FIGS. 1 and 2, or the like). In examples, the device may include one of a console of a NOC, a technician device associated with a field technician, an agent device associated with an agent of the service provider, or a user device associated with a customer of the service provider who is associated with a CPE among the plurality of CPE.

In an example, managing the plurality of CPE (at operation 305) further includes causing, for each of the plurality of CPE, a setting of one or more triggers for initiating testing and measuring of the network characteristics of the network over which that CPE communicatively couples with the responder server. Alternatively or additionally, in another example, managing the plurality of CPE (at operation 305) further includes causing, for each of the plurality of CPE, a setting of one or more conditions for pushing data from a local memory of that CPE to a corresponding one of the plurality of digital twins of data that is stored in the cloud storage database. Alternatively or additionally, in yet another example, managing the plurality of CPE (at operation 305) further includes causing, for each of the plurality of CPE, a setting of configurations for CPE operations.

In examples, each of the plurality of CPE has a dynamic IP address that is assigned to that CPE by a network gateway in response to a DHCP request sent by that CPE according to one of the following conditions: on a periodic basis, on a scheduled basis, after rebooting of the CPE, or in response to a user input. In some examples, each of the plurality of digital twins of data corresponding to one of the plurality of CPE includes at least one of summary data associated with a summary of one or more network characteristics measured by that CPE or raw data associated with the one or more network characteristics measured by that CPE. In examples, summary data associated with a summary of one or more network characteristics measured by each CPE is stored in a separate database accessible by the orchestration system. In such examples, method 300 may further include the orchestration system accessing the summary data from the separate database, and aggregating the one or more groups of network characteristics data into the one or more aggregated datasets (at operation 315) may include the orchestration system aggregating the one or more groups of network characteristics data and the summary data into the one or more aggregated datasets. In some instances, identifying the patterns in the one or more aggregated datasets (at operation 320) may include analyzing a combination of collective network characteristics data contained within each aggregated dataset among the one or more aggregated datasets and the summary data.

In some examples, updates to data stored in local memory of each CPE are pushed to the cloud storage database, by that CPE, to update a corresponding digital twin among the plurality of digital twins according to one of the following conditions: on a periodic basis, on a scheduled basis, after receiving a set number of measured metrics associated with the one or more network characteristics, prior to shutdown of that CPE, or in response to a user input. Alternatively or additionally, updates to data stored in local memory of each CPE are pushed to the cloud storage database to update a corresponding digital twin among the plurality of digital twins when raw data associated with a network characteristic among the one or more network characteristics that is measured by that CPE exceeds a threshold value.

FIGS. 4A and 4B (collectively, "FIG. 4") depict flow diagrams illustrating another example method 400 for implementing generation of real-time metrics of an edge-to-edge network, in accordance with various embodiments. Referring to FIG. 4, the operations of example method 400 may be performed by a CPE (e.g., CPE 105a-105o, 105p-105y, and 105 of FIGS. 1 and 2, or the like). In some examples, the CPE may include one of a pair of an ONT and an RG or a combination ONT/RG (e.g., a SmartNID) (e.g., ONT & RG / SmartNID 110a-110o, 110p-110y, and 110 of FIGS. 1 and 2, or the like).

In the example method 400 of FIG. 4A, at operation 405, a CPE, which is located at a customer premises (e.g., customer premises 115a-115o, 115p-115y, and 115 of FIGS. 1 and 2, or the like), may send at least one first test packet (e.g., test packet(s) 230 of FIG. 2, or the like) to a responder server (e.g., responder server(s) 175 of FIG. 2, or the like) in a core network (e.g., core network(s) 155 of FIG. 2, or the like) of a service provider over a path between the CPE and the responder server through a metro network of the service provider, in some cases, via a PON (e.g., PON 120 of FIG. 2, or the like), an OLT (e.g., OLT 125 of FIG. 2, or the like), and a network gateway (e.g., network/aggregation gateway(s) 205 of FIG. 2, or the like). At operation 410, the CPE may receive a response (e.g., response 235 of FIG. 2, or the like) to the at least one first test packet from the responder server. At operation 415, the CPE may measure one or more network characteristics, based on the response. At operation 420, the CPE may store the one or more network characteristics as part of first data in a local memory (e.g., local memory 220 of FIG. 2, or the like) of the CPE. At operation 425, the CPE may push data (e.g., data 225, including measured results 240, result summary 245, data updates 250, etc., of FIG. 2, or the like), which is stored in the local memory of the CPE, to a cloud storage database (e.g., cloud storage database 185 of FIG. 2, or the like), in which is stored a digital twin of the first data (e.g., digital twin 190 of FIG. 2, or the like).

In an example, the CPE may receive instructions from an orchestration system that cause a setting of one or more triggers for initiating testing and measuring of the one or more network characteristics. Alternatively or additionally, in another example, the CPE may receive instructions from an orchestration system that cause a setting of one or more conditions for pushing the first data from the local memory to the digital twin of the first data that is stored in the cloud storage database. Alternatively or additionally, in another example, the CPE may receive instructions from an orchestration system that cause a setting of configurations associated with CPE operations.

In some examples, the one or more network characteristics may include at least one of latency, packet loss, jitter, bandwidth, network speed, connectivity, or network performance, and/or the like. In an example, measuring the one or more network characteristics (at operation 415) includes mapping a connectivity of the path between the CPE and the responder server, by: (a) the CPE sending an Internet control message protocol ("ICMP") packet to the responder server over the path; (b) the CPE receiving a response from each router (e.g., router(s) 145a-145m of FIG. 2, or the like) along the path that routes the ICMP packet to the responder server, the response from each router including an ICMP timestamp that includes a date and time of that router; and (c) the CPE generating at least one of a connectivity map or a connectivity report based on the ICMP timestamp for each router. In some cases, the at least one of the connectivity map or the connectivity report may indicate (1) information regarding a number of routing hops along the path, (2) information regarding each router along the path, (3) information regarding whether each router is capable of transferring data, (4) information regarding packet latency along each routing hop, and (5) information regarding unresponsive or unreachable routers, and the like.

In an example, measuring the one or more network characteristics (at operation 415) includes the CPE measuring a network performance over the path between the CPE and the responder server, based on simple two-way active measurement protocol ("STAMP"). In another example, measuring the one or more network characteristics (at operation 415) includes the CPE measuring a network performance over the path between the CPE and the responder server, based on two-way active measurement protocol ("TWAMP"). In yet another example, measuring the one or more network characteristics (at operation 415) includes the CPE measuring a throughput of a payload that is sent over the path over transmission control protocol ("TCP"), in some cases, using TCP-based echo service, or the like. In examples, storing the one or more network characteristics (at operation 420) may include the CPE storing payload throughput measurement results as part of the first data in the local memory of the CPE. In still another example, measuring the one or more network characteristics (at operation 415) includes the CPE measuring a throughput of a datagram that is sent over the path over user datagram protocol ("UDP"), in some cases, using UDP-based echo service, or the like. In some examples, storing the one or more network characteristics (at operation 420) may include the CPE storing datagram throughput measurement results and packet loss results as part of the first data in the local memory of the CPE.

In another example, measuring the one or more network characteristics (at operation 415) includes performing a network speed test, by: (i) the CPE sending a plurality of second test packets to the responder server over the path over a first duration, and measuring a first network speed at which the plurality of second test packets is sent from the CPE to the responder server, where storing the one or more network characteristics (at operation 420) may include the CPE storing the first network speed in the local memory of the CPE; and (ii) the CPE receiving a plurality of third test packets from the responder server over the path over a second duration, and measuring a second network speed at which the plurality of third test packets is sent from the responder server to the CPE, where storing the one or more network characteristics (at operation 420) may include the CPE storing the second network speed in the local memory of the CPE.

In examples, the CPE may generate summary data based on the one or more network characteristics measured by the CPE, and may store the summary data in the local memory. In an example, pushing the first data that is stored in the local memory to the cloud storage database (at operation 425) includes the CPE pushing the summary data from the local memory to the cloud storage database, where the digital twin of the first data that is stored in the cloud storage database is updated with the summary data. Alternatively or additionally, in another example, pushing the first data that is stored in the local memory to the cloud storage database (at operation 425) includes the CPE pushing raw data associated with the one or more network characteristics measured by that CPE from the local memory to the cloud storage database, where the digital twin of the first data that is stored in the cloud storage database is updated with the raw data. In some examples, the CPE may push updates of the first data that are stored in the local memory to the cloud storage database to update the digital twin of the first data according to one of the following conditions: (i) on a periodic basis, (ii) on a scheduled basis, (iii) after receiving a set number of measured metrics associated with the one or more network characteristics, (iv) prior to shutdown of that CPE, (v) in response to a user input, or (vi) when raw data associated with the one or more network characteristics measured by the CPE exceeds a threshold value, and/or the like.

Referring to FIG. 4B, method 400, at operation 430, may include the CPE sending a DHCP request (e.g., IP request 210 of FIG. 2, or the like) to the network gateway. At operation 435, the CPE may receive an indication of a new IP address (e.g., IP address 215 of FIG. 2, or the like) that has been assigned to the CPE by the network gateway. At operation 440, the CPE may update the local memory with the new IP address. In examples, the new IP address is a dynamic IP address, and the DHCP request may be sent according to one of the following conditions: on a periodic basis, on a scheduled basis, after rebooting of the CPE, or in response to a user input, and/or the like.

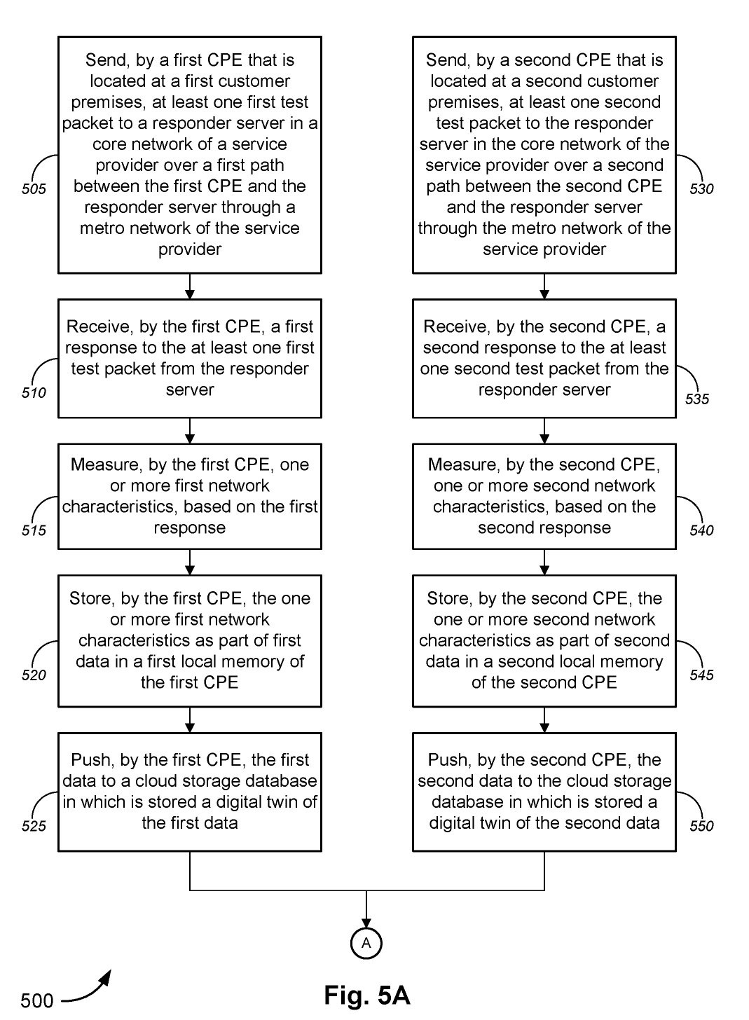

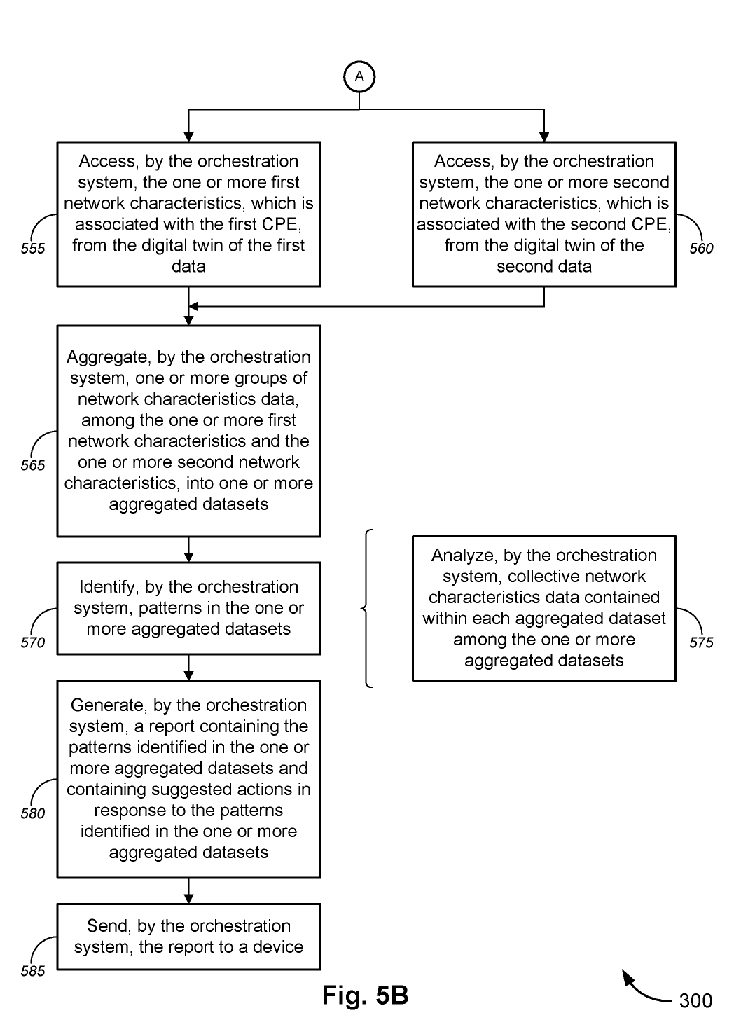

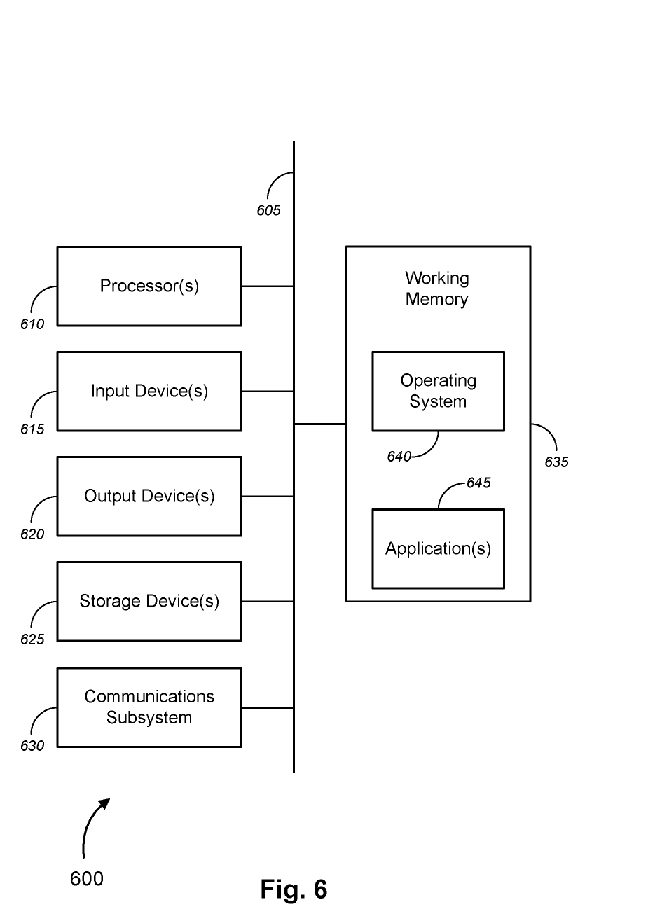

FIGS. 5A and 5B (collectively, "FIG. 5") depict flow diagrams illustrating yet another example method 500 for implementing generation of real-time metrics of an edge-to-edge network, in accordance with various embodiments. Method 500 is directed to a combination of operations of an orchestration system (such as described above with respect to FIG. 3, or the like) and interactions between each of multiple CPE (in this case, a first CPE and a second CPE) and a responder server (such as described above with respect to FIGS. 4A and 4B, or the like), and the description of the methods 300 and 400 of FIGS. 3 and 4A-4B, respectively, are similarly applicable to the corresponding portions of method 500 of FIGS. 5A and 5B. Method 500 of FIG. 5A continues onto FIG. 5B following the circular marker denoted, "A."

With reference to FIG. 5A, example method 500, at operation 505, may include a first CPE, which is located at a first customer premises, sending at least one first test packet to a responder server in a core network of a service provider over a first path between the first CPE and the responder server through a metro network of the service provider. At operation 510, the first CPE may receive a first response to the at least one first test packet from the responder server. At operation 515, the first CPE may measure one or more first network characteristics, based on the first response. At operation 520, the first CPE may store the one or more first network characteristics as part of first data in a first local memory of the first CPE. At operation 525, the first CPE may push the first data, which is stored in the first local memory, to a cloud storage database in which is stored a digital twin of the first data. Method 500 may continue onto the process at operation 555 and/or the process at operation 560 in FIG. 5B following the circular marker denoted, "A."

Before, concurrent with, or after the processes at operations 505-525, a second CPE that is located at a second customer premises as described below with respect to the processes at operations 530-550. At operation 530, the second CPE may send at least one second test packet to the responder server in the core network of the service provider over a second path between the second CPE and the responder server through the metro network of the service provider. At operation 535, the second CPE may receive a second response to the at least one second test packet from the responder server. At operation 540, the second CPE may measure one or more second network characteristics, based on the second response. At operation 545, the second CPE may store the one or more second network characteristics as part of second data in a second local memory of the second CPE. At operation 550, the second CPE may push the second data, which is stored in the second local memory, to the cloud storage database in which is stored a digital twin of the second data. Method 500 may continue onto the process at operation 555 and/or the process at operation 560 in FIG. 5B following the circular marker denoted, "A."

At operation 555 in FIG. 5B (following the circular marker denoted, "A," in FIG. 5A), method 500 may include an orchestration system accessing the one or more first network characteristics, which is associated with the first CPE, from the digital twin of the first data. Alternatively or additionally, at operation 560, the orchestration system may access the one or more second network characteristics, which is associated with the second CPE, from the digital twin of the second data. Method 500 may continue onto the process at operation 565. At operation 565, the orchestration system may aggregate one or more groups of network characteristics data, among the one or more first network characteristics and the one or more second network characteristics, into one or more aggregated datasets. At operation 570, the orchestration system may identify patterns (including trends, etc.) in the one or more aggregated datasets, by analyzing collective network characteristics data contained within each aggregated dataset among the one or more aggregated datasets (at operation 575). At operation 580, the orchestration system may generate a report containing the patterns identified in the one or more aggregated datasets and containing suggested actions in response to patterns identified in the one or more aggregated datasets; and sending the report to a device.

In examples, each of the digital twin of the first data and the digital twin of the second data includes at least one of summary data associated with a summary of one or more network characteristics measured by that CPE or raw data associated with the one or more network characteristics measured by that CPE. In some examples, the orchestration system may manage each of the first CPE and the second CPE, in terms of pushing of network characteristics to a corresponding digital twin of data being stored in the cloud storage database. In an example, managing each of the first CPE and the second CPE may include causing, for each of the first CPE and the second CPE, a setting of one or more triggers for initiating testing and measuring of the network characteristics of the network over which that CPE communicatively couples with the responder server. In some cases, the network characteristics may include at least one of latency, packet loss, jitter, bandwidth usage, network speed, connectivity, or network performance, and/or the like. In another example, managing each of the first CPE and the second CPE may include causing, for each of the first CPE and the second CPE, a setting of one or more conditions for pushing data from the local memory of that CPE to a corresponding digital twin that is stored in the cloud storage database. In yet another example, managing each of the first CPE and the second CPE may include causing, for each of the first CPE and the second CPE, a setting of configurations for CPE operations.

In some examples, the orchestration system and the cloud storage database may be disposed in the core network. In some instances, each CPE of the plurality of CPE includes one of a pair of an ONT and an RG or a combination ONT/RG or SmartNID. In examples, the device may include one of a console of a NOC, a technician device associated with a field technician, an agent device associated with an agent of the service provider, a first user device associated with a first customer who is associated with the first CPE, or a second user device associated with a second customer who is associated with the second CPE, and/or the like.

While the techniques and procedures in methods 300, 400, and 500 are depicted and/or described in a certain order for purposes of illustration, it should be appreciated that certain procedures may be reordered and/or omitted within the scope of various embodiments. Moreover, while the methods 300, 400, and 500 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400, and 500 (e.g., by executing instructions embodied on a computer readable medium), the systems, examples, or embodiments 100 and 200 of FIGS. 1 and 2 can each also operate according to other modes of operation and/or perform other suitable procedures.

### Exemplary System and Hardware Implementation

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., CPE 105a-105o, 105p-105y, and 105, ONT and RG / SmartNID 110a-110o, 110p-110y, and 110, OLT 125a-125n and 125, broadband network gateways 130a-130n, routers 145a-145k, 145l-145x, and 145a-145m, aggregation gateways 150aand 150b, server 160, responder server(s) 175, orchestration system 180a, 180b, and 180, device(s) 195, network/aggregation gateway(s) 205, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600 – which might represent an embodiment of the computer or hardware system (i.e., CPE 105a-105o, 105p-105y, and 105, ONT and RG / SmartNID 110a-110o, 110p-110y, and 110, OLT 125a-125nand 125, broadband network gateways 130a-130n, routers 145a-145k, 145l-145x, and 145a-145m, aggregation gateways 150aand 150b, server 160, responder server(s) 175, orchestration system 180a, 180b, and 180, device(s) 195, network/aggregation gateway(s) 205, etc.), described above with respect to FIGS. 1-5 – is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory ("RAM") and/or a read-only memory ("ROM"), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network ("WWAN") device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines ("VMs"), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms "machine readable medium" and "computer readable medium," as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
sending, by a customer premises equipment ("CPE") that is located at a customer premises, at least one first test packet to a responder server in a core network of a service provider over a path between the CPE and the responder server through a metro network of the service provider;
receiving, by the CPE, a response to the at least one first test packet from the responder server;
measuring, by the CPE, one or more network characteristics, based on the response;
storing, by the CPE, the one or more network characteristics as part of first data in a local memory of the CPE; and
pushing, by the CPE, the first data, which is stored in the local memory of the CPE, to a cloud storage database in which is stored a digital twin of the first data.

2. The method of claim 1, wherein the CPE includes one of a pair of an optical network terminal ("ONT") and a residential gateway ("RG") or a combination ONT/RG ("SmartNID"), and wherein the at least one first test packet is sent over the path through the metro network via a passive optical network ("PON"), an optical line terminal ("OLT"), and a network gateway.

3. The method of claim 1, further comprising:
sending, by the CPE, a dynamic host configuration protocol ("DHCP") request to a network gateway;
receiving, by the CPE, an indication of a new Internet protocol ("IP") address that has been assigned to the CPE by the network gateway; and
updating, by the CPE, the local memory with the new IP address;
wherein the new IP address is a dynamic IP address, and the DHCP request is sent according to one of the following conditions: on a periodic basis, on a scheduled basis, after rebooting of the CPE, or in response to a user input.

4. The method of claim 1, further comprising:
receiving, by the CPE, instructions from an orchestration system that cause at least one of:
a setting of one or more triggers for initiating testing and measuring of the one or more network characteristics, wherein the one or more network characteristics include at least one of latency, packet loss, jitter, bandwidth usage, network speed, connectivity, or network performance;
a setting of one or more conditions for pushing the first data from the local memory to the digital twin of the first data that is stored in the cloud storage database; or
a setting of configurations associated with CPE operations.

5. The method of claim 1, further comprising:
generating, by the CPE, summary data based on the one or more network characteristics measured by the CPE;
storing, by the CPE, the summary data in the local memory; and
wherein pushing the first data that is stored in the local memory to the cloud storage database comprises at least one of:
pushing, by the CPE, the summary data from the local memory to the cloud storage database, wherein the digital twin of the first data that is stored in the cloud storage database is updated with the summary data; or
pushing, by the CPE, raw data associated with the one or more network characteristics measured by that CPE from the local memory to the cloud storage database, wherein the digital twin of the first data that is stored in the cloud storage database is updated with the raw data.

6. The method of claim 1, further comprising:
pushing, by the CPE, updates of the first data that are stored in the local memory to the cloud storage database to update the digital twin of the first data according to one of the following conditions: on a periodic basis, on a scheduled basis, after receiving a set number of measured metrics associated with the one or more network characteristics, prior to shutdown of that CPE, or in response to a user input.

7. The method of claim 1, further comprising:
pushing, by the CPE, updates of the first data that are stored in the local memory to the cloud storage database to update the digital twin of the first data when raw data associated with the one or more network characteristics measured by the CPE exceeds a threshold value.

8. The method of claim 1, wherein measuring the one or more network characteristics comprises mapping a connectivity of the path between the CPE and the responder server, by:
sending, by the CPE, an Internet control message protocol ("ICMP") packet to the responder server over the path;
receiving, by the CPE, a response from each router along the path that routes the ICMP packet to the responder server, the response from each router including an ICMP timestamp that includes a date and time of that router; and
generating, by the CPE, at least one of a connectivity map or a connectivity report based on the ICMP timestamp for each router, the at least one of the connectivity map or the connectivity report indicating information regarding a number of routing hops along the path, information regarding each router along the path, information regarding whether each router is capable of transferring data, information regarding packet latency along each routing hop, and information regarding unresponsive or unreachable routers.

9. The method of claim 1, wherein measuring the one or more network characteristics comprises performing one of:
measuring, by the CPE, a network performance over the path between the CPE and the responder server, based on simple two-way active measurement protocol ("STAMP");
measuring, by the CPE, a network performance over the path between the CPE and the responder server, based on two-way active measurement protocol ("TWAMP");
measuring, by the CPE, a throughput of a payload that is sent over the path over transmission control protocol ("TCP"), wherein storing the one or more network characteristics includes storing, by the CPE, payload throughput measurement results as part of the first data in the local memory of the CPE; or
measuring, by the CPE, a throughput of a datagram that is sent over the path over user datagram protocol ("UDP"), wherein storing the one or more network characteristics includes storing, by the CPE, datagram throughput measurement results and packet loss results as part of the first data in the local memory of the CPE.

10. The method of claim 1, wherein measuring the one or more network characteristics comprises performing a network speed test, by:
sending, by the CPE, a plurality of second test packets to the responder server over the path over a first duration, measuring a first network speed at which the plurality of second test packets is sent from the CPE to the responder server, wherein storing the one or more network characteristics includes storing, by the CPE, the first network speed in the local memory of the CPE; and
receiving, by the CPE, a plurality of third test packets from the responder server over the path over a second duration, measuring a second network speed at which the plurality of third test packets is sent from the responder server to the CPE, wherein storing the one or more network characteristics includes storing, by the CPE, the second network speed in the local memory of the CPE.

11. A system, comprising:
a first customer premises equipment ("CPE") that is located at a first customer premises, the first CPE performing first operations comprising:
sending at least one first test packet to a responder server in a core network of a service provider over a first path between the first CPE and the responder server through a metro network of the service provider;
receiving a first response to the at least one first test packet from the responder server;
measuring one or more first network characteristics, based on the first response;
storing the one or more first network characteristics as part of first data in a first local memory of the first CPE; and
pushing the first data, which is stored in the first local memory, to a cloud storage database in which is stored a digital twin of the first data;
a second CPE that is located at a second customer premises, the second CPE performing second operations comprising:
sending at least one second test packet to the responder server in the core network of the service provider over a second path between the second CPE and the responder server through the metro network of the service provider;
receiving a second response to the at least one second test packet from the responder server;
measuring one or more second network characteristics, based on the second response;
storing the one or more second network characteristics as part of second data in a second local memory of the second CPE; and
pushing the second data, which is stored in the second local memory, to the cloud storage database in which is stored a digital twin of the second data; and
an orchestration system, comprising:
a processing system; and
memory coupled to the processing system, the memory comprising computer executable instructions that, when executed by the processing system, causes the orchestration system to perform third operations comprising:
accessing the one or more first network characteristics, which is associated with the first CPE, from the digital twin of the first data; accessing the one or more second network characteristics, which is associated with the second CPE, from the digital twin of the second data; aggregating one or more groups of network characteristics data, among the one or more first network characteristics and the one or more second network characteristics, into one or more aggregated datasets;
identifying patterns in the one or more aggregated datasets, by analyzing collective network characteristics data contained within each aggregated dataset among the one or more aggregated datasets;
generating a report containing the patterns identified in the one or more aggregated datasets and containing suggested actions in response to patterns identified in the one or more aggregated datasets; and
sending the report to a device.

12. The system of claim 11, wherein each of the digital twin of the first data and the digital twin of the second data includes at least one of summary data associated with a summary of one or more network characteristics measured by that CPE or raw data associated with the one or more network characteristics measured by that CPE.

13. The system of claim 11, wherein the third operations further comprise:managing each of the first CPE and the second CPE, in terms of pushing of network characteristics to a corresponding digital twin of data being stored in the cloud storage database.

14. The system of claim 13, wherein managing each of the first CPE and the second CPE includes at least one of:
causing, for each of the first CPE and the second CPE, a setting of one or more triggers for initiating testing and measuring of the network characteristics of a network over which that CPE communicatively couples with the responder server, wherein the network characteristics include at least one of latency, packet loss, jitter, bandwidth usage, network speed, connectivity, or network performance;
causing, for each of the first CPE and the second CPE, a setting of one or more conditions for pushing data from a corresponding local memory of that CPE to a corresponding digital twin that is stored in the cloud storage database; or
causing, for each of the first CPE and the second CPE, a setting of configurations for CPE operations.

15. The system of claim 11, wherein the orchestration system and the cloud storage database are disposed in the core network.

16. The system of claim 11, wherein each CPE of the first and second CPE includes one of a pair of an optical network terminal ("ONT") and a residential gateway ("RG") or a combination ONT/RG ("SmartNID").

17. The system of claim 11, wherein the device includes one of a console of a network operations center ("NOC"), a technician device associated with a field technician, an agent device associated with an agent of the service provider, a first user device associated with a first customer who is associated with the first CPE, or a second user device associated with a second customer who is associated with the second CPE.

18. A method, comprising:
managing, by an orchestration system, each of a plurality of customer premises equipment ("CPE"), which is disposed at one of a corresponding plurality of customer premises, in terms of pushing of network characteristics among a plurality of network characteristics data from the plurality of CPE to a plurality of digital twins being stored in a cloud storage database, the plurality of network characteristics data each corresponding to network characteristics of a network of a service provider between a responder server in a core network of a service provider and one of the plurality of CPE;
accessing, by the orchestration system, the plurality of network characteristics data from the plurality of digital twins of data that is stored in the cloud storage database;
aggregating, by the orchestration system, one or more groups of network characteristics data, among the plurality of network characteristics data, that are associated with one or more groups of CPE, among the plurality of CPE, into one or more aggregated datasets;
identifying, by the orchestration system, patterns in the one or more aggregated datasets, by analyzing collective network characteristics data contained within each aggregated dataset among the one or more aggregated datasets;
generating, by the orchestration system, a report containing patterns identified in the one or more aggregated datasets and containing suggested actions in response to the patterns identified in the one or more aggregated datasets; and
sending, by the orchestration system, the report to a device.

19. The method of claim 18, wherein managing the plurality of CPE further includes at least one of:
causing, for each of the plurality of CPE, a setting of one or more triggers for initiating testing and measuring of the network characteristics of the network over which that CPE communicatively couples with the responder server, wherein the network characteristics include at least one of latency, packet loss, jitter, bandwidth usage, network speed, connectivity, or network performance;
causing, for each of the plurality of CPE, a setting of one or more conditions for pushing data from a local memory of that CPE to a corresponding one of the plurality of digital twins of data that is stored in the cloud storage database; or
causing, for each of the plurality of CPE, a setting of configurations for CPE operations.

20. The method of claim 18, wherein summary data associated with a summary of one or more network characteristics measured by each CPE is stored in a separate database accessible by the orchestration system, wherein the method further comprises:
accessing, by the orchestration system, the summary data from the separate database;
wherein aggregating the one or more groups of network characteristics data into the one or more aggregated datasets includes aggregating, by the orchestration system, the one or more groups of network characteristics data and the summary data into the one or more aggregated datasets; and
wherein identifying the patterns in the one or more aggregated datasets includes analyzing a combination of collective network characteristics data contained within each aggregated dataset among the one or more aggregated datasets and the summary data.
